(19) United States
(12) Patent Application Publication
(10) Pub. No.: US 2014/0195379 A1
(43) Pub. Date: Jul. 10, 2014

(54) Technology Alternative to Money for Enabling Equitable Trade

(71) Applicants: Martin Alexander Hay, Prestbury (GB); Frances Geralyn Boul Hay, Prestbury (GB)

(72) Inventors: Martin Alexander Hay, Prestbury (GB); Frances Geralyn Boul Hay, Prestbury (GB)

(21) Appl. No.: 14/236,630

(22) PCT Filed: Oct. 17, 2012
(86) PCT No.: PCT/US12/60514

§ 371 Date: Feb. 2, 2014

Related U.S. Application Data
(60) Provisional application No. 61/588,419, filed on Jan. 19, 2012.
(60) Provisional application No. 61/646,387, filed on May 14, 2012.

(30) Foreign Application Priority Data
Oct. 18, 2011 (GB) 1117954.6
Nov. 11, 2011 (GB) PCT/GB2011/001583

(51) Int. Cl. G06Q 30/06

(52) U.S. Cl. CPC G06Q 30/0619
USPC 705/26.44

(57) ABSTRACT

Technology, alternative to money, for enabling equitable trade between users. The technology embodies chiralkine money and chiralkine property rights created as vectors through chiralkine contracts made by a recorder that maintains an open register and a trading pair of two users.

In the United States, this application is a continuation-in-part (claims the benefit under 35 U.S.C 120) of international patent application number PCT/GB2011/001583 filed on Nov. 11, 2011 designating the United States, and also claims the benefit under 35 U.S.C. 119 (e) of U.S. provisional patent application No. 61/588,419 filed on Jan. 19, 2012 and U.S. provisional patent application No. 61/646,387 filed on May 14, 2012, each of which is incorporated by reference herein.

The present invention relates to technology, alternative to money, for enabling users to engage in equitable trade. The technology embodies chiralkine money and chiralkine property rights created as vectors through chiralkine contracts made by users in a trading pair and a recorder that maintains an open register.

It appears that life evolved in jumps, like the course of innovation. One major jump is hypothesised to have been the change from a single-stranded (symmetric) RNA world to a double-stranded (antisymmetric) DNA world. In the recent history of mankind, there has been huge innovation in many areas, from electronics to bioscience. However, the monetary systems of the world have remained largely unchanged for thousands of years. Value is deemed embodied in a single token (money) that can be exchanged in return for goods or services. The monetary system is like an RNA world. So central to our worldview has money become that people tend to believe it is a real thing. It is not. It is a purely intellectual (or legal) construct, like intellectual property, embodied in technology. Money is technology embodying a vector representing an unfulfilled part of a contract.

The classical Newtonian model accords with our everyday experience of life, but close observation by scientists revealed anomalies that cannot be explained by the classical laws of physics. This led to the creation of new theories, including quantum theory with its concepts of symmetric and antisymmetric wave functions, and the theory of relativity. These theories accounted for the anomalies, and spurred technical innovation in many fields. As will become apparent from an understanding of the present invention, the vector-based mathematics behind these theories also has a highly unexpected application in the fields of monetary systems and the law of property rights.

It does not take the trained mind of a highly skilled scientist to recognise that the monetary systems of the world do not behave in a predicable manner. There are many competing ideas for addressing this, but all are based upon the belief that a workable system can be found based upon money in its current form. There is always someone else to blame when things go wrong. All of the proposed solutions: better regulation of the banks, reduced budget deficits, increased government spending and alternative currencies involve using the same kind of monetary system.

Presently unemployment, particularly amongst the young, is dangerously high. Nationalist tendencies, which strengthen during financial depressions, are starting to create tensions the like of which we have not seen for generations. Too many people are becoming disconnected from the monetary system, because you need money to live, and you need a job to get money.

The website http://www.transaction.net/money/ provides a summary of the known kinds of money It defines money as an agreement within a community to use something as a medium of exchange.

Monetary systems are used in industry to couple the steps of production. Industry could not function without a monetary system. They comprise technical components used as physical representations of money, for example beads, shells, tallies such as tally sticks, tokens (such as coins or paper documents such as banknotes, bills of exchange or accounts) and electronic records such as digital coins (for example BITCOIN) or electronic bank accounts.

Money is a medium for the exchange of goods and services between people (P2P). Each time goods or services (G) are provided by one person (P) to another (P), money (M) is provided in return.

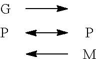

To an impartial observer, each step appears to be the same, and thus goods and services appear to move in cycles in counter-current to money.

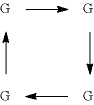

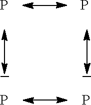

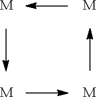

Each person, however, has a sense of identity: of self. Each of you (the reader) and I (the writer) thinks of ourselves as “me” and the other of us as “you”. As Descartes put it “I think, therefore I am”.

Consequently, it appears to every person that the exchange process comprises two distinct steps: sale (for money) and purchase (with money).

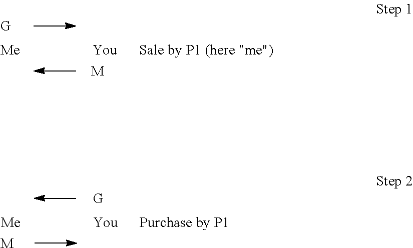

The “you” in step 1 can be the same (P2) or different (P3) to the “you” in step 2. If the two are the same, there is actually a simple exchange of goods or services, as in barter.

The sense of identity of each person also gives rise to a sense of property ownership. P1 would describe goods in his or her possession as “mine not yours”, and those in the possession of P2 as “yours not mine”. When goods or services change hands between two people for money, their status changes from “mine not yours” to “yours not mine” from the perspective of one of the two people, and from “yours not mine” to “mine not yours” from the perspective of the other.

In common parlance, the words “not yours” and “not mine” are dropped, so that people speak simply of “mine” and “yours”. However, each of the terms “mine” and “yours” excludes the other, unlike in the cases of the terms “everybody's” (belongs to everyone) and “nobody's”, (belongs to no-one) where there is no implied “not”. Something that belongs to everyone belongs to me, to you and to everyone else. Something that belongs to nobody does not belong to me, to you or to anyone else.

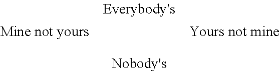

The terms “everybody's” and “nobody's” are symmetric opposites. There is nothing to distinguish one person from any other. The terms “mine not yours” and “yours not mine” are antisymmetric opposites. The people are distinguished one from another: they each have an identity. The word “not” is characteristic of an antisymmetric relationship. If people did not have a sense of identity, then trade in goods and services would appear to be a symmetric process: there would be no distinction between “sale” and “purchase”. People are familiar with antisymmetric relationships, but are very unfamiliar with the concept of antisymmetry. For example, people are familiar with the positive and negative terminals of a battery. The positive terminal is “positive not negative”, and the negative terminal is “negative not positive”. Positive and negative charges attract one another, but each repels its own kind. The poles of a magnet behave similarly. Antisymmetry is intimately related to handedness, which is a fundamental symmetry of nature. Right and left hands are antisymmetric opposites. You can imagine turning a left hand into a right hand by rotating it through 180 degrees and then reflecting it in mirror (looking at it in a mirror).

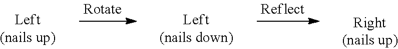

Money is used to effect transitions between “mine not yours” and “yours not mine”, not between “everybody's” and “nobody's” or between “mine not yours” or “yours not mine” and “everybody's” or “nobody's”. It is thus used to effect transitions between antisymmetric opposite states, as in switching from a left hand to a right hand by rotation and reflection. There is a hidden handedness about money. Note for future reference that a left hand is not a negative right hand. You cannot make a left hand by subtracting a right hand.

Thus, money is a medium for facilitating the exchange of goods or services between people. It moves in counter-current (in the opposite direction) to the flow of goods or services. The sense of identity in each person gives rise to a perception that there are two distinct steps in the exchange process: purchase and sale. This perception has its roots in handedness or chirality, a fundamental symmetry of nature. Money is thus concerned with chirality (from the Greek χειρo for hand) and kinetics (from the Greek kinesi: κiνησΛç for movement). This invention is based upon a new kind of money: “chiralkine” money, the name of which has its origins in the Greek words for hand and movement.

Money does not arise spontaneously. It is not induced by the movement of goods or services. It has to be created. The creation and use of money are independent processes. As will be explained below, confusion of the two processes, caused primarily by banks acting as intermediaries, is an underlying cause for the instability of the current monetary system, manifested by asset price bubbles, trade-imbalances and growing inequality.

To understand the creation of money, imagine that one person wishes to buy goods or services from another, but has no money. If the vendor trusts the purchaser, he/she can provide the goods or services on condition that the purchaser pays for these at a future date. The vendor is said to provide the purchaser with credit. As a token formalising the agreement between the two people, the purchaser may provide an IOU (I owe you).

An IOU is not money, because it is not recognised by other people as imposing any right or obligation on them. For an IOU to become money, the original vendor, purchaser and everyone else who wishes to use the IOU as the money needs to recognise it as being exchangeable for goods or services. If such an IOU were to be so recognised, it could circulate through a trading community until eventually the original purchaser receives it in exchange for some goods or services that he or she has provided. At that point, the IOU is redeemed. Note that for an IOU to become money, all members of a trading community must accept that it matters to them that goods or services are conditionally being transferred from one member of the community (the original vendor) to another (the original purchaser). What would normally appear to other members of a trading community to be a symmetric situation (where it does not matter who has the goods or services) becomes viewed as an antisymmetric situation (where it does matter). Thus, for an IOU arising out of a private contract between two people to become money, all members of a trading community must recognise that they all have an interest in the performance (completion) of the contract. The creation of money has its origins in a special form of contract between two people engaged in trade, which contract gives rise to rights and obligations affecting all members of a trading community. It is as if the two people, the original vendor and purchaser, create a law binding on everyone.

One way for money to become law is for the State to enact it. When a state decrees that something will be accepted as payment of taxes, it becomes money. Alternatively, members of a trading community can choose to recognise IOUs as money without the force of the law (of the State). Many such communities operate in this way, for example using mutual credit systems.

The drawing of a distinction between purchase and sale (consequent on the belief in the self being distinct from other) has given rise to a convention for accounting for transactions: double entry bookkeeping. This is used as a basis for mutual credit systems, for example the LETS system of mutual credit, associated with Michael Linton.

In double entry bookkeeping, the transfer of money can be treated as a debit for the purchaser and a credit for the vendor.

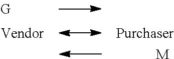

Step 1: debit M from purchaser account
Step 2: credit M to vendor account.

A debit is treated as equivalent to a negative credit. Thus the sum of a debit and a credit is zero:
debit+debit=2 debits debit−debit=0
credit+credit=2 credits credit−credit=0
credit+debit=0

This system of accounting works extremely well for accounting for transfers of money in the course of trade (exchange of money for goods and services, and works perfectly satisfactorily for small scale mutual credit systems, such as LETS. However, it does not work on a large scale for the creation of money. The problem comes when double entry bookkeeping is used to account for the creation of money. It does not work! With the creation of money, debit+credit≠0! A left hand is not a negative right hand.

Bartering organisations, including web-based bartering organisations based upon money created by the users are known. See for example, U.S. Pat. No. 7,702,540 assigned to eBay Inc. Examples include not-for-profit mutual credit systems and commercial systems. Two users can agree that one will barter some goods or service in return for created money (which may be in units of favours). The problem with this is that two users entering into a bartering transaction will not be trusted by everyone else to create money of the correct value. The money cannot be used as a means of exchange between all people in a bartering organisation.

There has been speculation over whether E-barter might one day obviate the need for fiat money (see F. H. Capie, Dimitrios P. Tsomocos and Geoffrey E. Wood, Bank of England Working Paper No. 197, 2003 available from Publications Group, Bank of England, Threadneedle Street, London, EC2R 8AH). The authors conclude that fiat money is superior transaction technology to electronic barter.

In 1100 AD, King Henry 1 of England, faced with an acute shortage of coins, introduced what is known as the split tally stick system. This system was used in Europe for over 700 years, when it was replaced with fiat money. In this system, a person could provide goods to another in return for a promise of future repayment. The value of the promise was recorded as notches cut on a stick, usually of hazel wood. The stick was then split in two, one half being retained by each party to the transaction. It was extremely difficult to commit fraud with this system, because the grain of the wood on a genuine half stick would not match up with that on a counterfeit half stick. The half stick retained by the creditor was known as the stock (from which the term “stocks and shares” is derived), and that retained by the debtor the foil. The foil was often cut shorter than the stock, (hence the origin of the term “to get the short end of the stick”). The King required that taxes be paid in tally sticks. Hence these sticks began to be used as money. A major advantage of the split tally system was that it avoided the need for moneylenders and banks (which charge interest for loans) and ensured that the value of money is based upon the production of the people.

International patent application number PCT/GB2011/001583 filed on Nov. 11, 2011 (Armistice Day) recognises that the conventional wisdom that money is symmetric is flawed. The function of money is antisymmetric. The application proposes a new monetary system, based upon left- and right-handed money and left- and right-handed property rights. The idea of replacing each of the something that is money and the something that is an ownership right with two opposite things represents a paradigm shift.

The present invention builds on the concept of left- and right handed money. It provides a means by which the unemployed and disadvantaged, indeed anyone, can create left- and right-handed money by going without something for the benefit of another in a bartering transaction, which money can be trusted by others. No bank loan is needed. People all over the world can do things for one another and create capital to start new businesses without having to borrow fiat money. Banks are no longer needed. The widening inequality in wealth is arrested.

According to one aspect therefore, the present invention provides a web-based system for a bartering organisation and users thereof, which comprises:
(a) means for creating user agreements between said bartering organisation and said users; and
(b) means for implementing user agreements between said bartering organisation and said users, comprising:
(i) means for representing chiralkine money;
(ii) means for representing and operating user accounts in chiralkine money;
(iii) means for representing monopole property rights;
(iv) means for representing chiralkine property rights;
(v) a web-based bartering market for creating barter transaction agreements between users for monopole property rights or chiralkine property rights in chiralkine money;
(vi) means for creating credit agreements between said bartering organisation and users subject to a barter transaction agreement;
(vii) means for implementing said barter transaction agreements; and
(viii) means for implementing said credit agreements, including means for creating chiralkine money, means for creating chiralkine property rights when said chiralkine money is created; means for destroying chiralkine money, and means for collapsing chiralkine property rights into monopole property rights when said chiralkine money is destroyed.

A key feature of the present invention is that it enables right- and left-handed chiralkine money to be created for those that most need it, which can be trusted like money based on gold by all users of the invention. The value represented by the right- and left-handed chiralkine money is based upon the motive force of two people to complete a barter that began by one person going without for the benefit of the other and can be calibrated against a web-based market that determines prices for barters.

It will be appreciated that the present invention is not a method by which one person can earn money from another through trade (a business method), but a technology-based system useful in industry, to couple together the steps of production. Not to recognise this in law would be to privilege the private interests of the financial services industry engaged in the exploitation of the present monetary systems over the interests of the public to be able to engage in equitable trade using a system that can (with investment) be developed as an alternative to the present monetary systems.

As will become apparent from gaining an understanding of the invention, chiralkine money provides the basis for a new monetary and property rights system that addresses the problems of trade imbalances, asset price bubbles, sovereign budget deficits and inequality associated with current monetary systems. It builds on the strengths of the split tally stick system used successfully in Europe for hundreds of years. It consists of two mirror forms that are created temporarily by contract by two people wishing to initiate trade, travel through a trading community propagating trades and then mutually cancel at the completion of the contract, when each of the two people has both provided and received some trade or service. The contract is at once between the two people each to the other and also between the pair (as a whole) and the trading community, thus supporting the potency of the created money throughout its lifetime. The distinct steps of initiation, propagation and termination cleanly separate the creation and redemption of money from use of money into independent processes, and hold all those responsible for creating money to account. The steps thus address a fundamental flaw in current monetary systems, where the creation of money by commercial and central banks is obscured by its use, and those responsible for creating money can escape accountability. Unlike conventional money, chiralkine money is not a store of value, nor can it be used to pay off debt. It is a pair of vectors that facilitates equitable trade. It requires no banks, involves no interest payments and can readily be adapted for taxation to support public services. It can be introduced as a complementary currency alongside conventional money without disturbing existing property rights. Each of its mirror forms can be made exchangeable at fixed or floating exchange rates with conventional currencies, thus enabling integration of chiralkine money with existing monetary systems and also providing a mechanism for closing down a chiralkine system should this become necessary. The system is particularly adapted for deployment on an electronic platform. Mutual credit systems such as LETS can readily be converted into chiralkine systems. Moreover, because it identifies both parties to any transaction, it is very secure, and thus resistant to abuse through fraud or money-laundering.

### DEFINITIONS

Web-based: comprising an information transmission network, as in the worldwide web (internet) or a telecommunications network as used with landline and cellular (mobile) phones.

Barter: equitable trade in goods or services using chiralkine money.

Bartering organisation: an (equitable trade) organisation that enables users to enter into and complete bartering transactions with one another. The bartering organisation can be a not-for-profit organisation (i.e. wholly chiralkine based) or a for profit organisation (i.e. from which profits in monopole money can be derived). Several or indeed many bartering organisations can co-exist, each using their own chiralkine money. A bartering organisation can be established and operate in just one state or internationally. It could form the basis for the economy of an entire state. A bartering organisation is like a bank in the sense that it maintains accounts in chiralkine money for users, but is unlike a bank in that it requires instructions from two users, one for each of the two forms of chiralkine money, in order to effect simultaneous changes in the accounts of both users. It is a recorder: a keeper of a register, not a safe repository for a store of value belonging to a user.

User: a person who uses the bartering organisation to barter for goods or services. A user can be any person, including a legal person such as a chiralkine corporation, a registered charity, a governmental body, an international organisation or a state. Two or more persons, such as husband and wife, can jointly be a user. In one embodiment, the users comprise professional sports clubs engaged in the barter of player contracts.

Means as in “means for”: technology for producing a technical effect, as opposed to a human mind for performing a mental act. Each feature of the invention requires technology to embody it, just as conventional money requires technology to embody it, be this beads, shells, coins or electronic records.

Chiralkine money: left and/or right handed money. Chiralkine money is not a store of value like monopole money, but a pair of vectors representing the unfulfilled parts of a chiralkine contract.

User account: an account maintained by the bartering organisation that contains a record of the chiralkine money belonging to a user (left and/or right-handed).

Monopole property right: a property right that has no left- and right-handed forms.

Chiralkine property right: a left and/or right handed property right.

Credit agreement: also known as a chiralkine contract. A contract between in one part of the contract, the two members of a pair of people each to the other who create chiralkine money, and in another part of the contract, between a bartering organisation and the pair of people as a whole indivisible unit. It is a contract through which symmetry is broken. It will be appreciated that the term “credit” is not being given its ordinary meaning in this patent specification. One party does not advance credit (make a loan requiring repayment) to another in a chiralkine system, but instead both receive chiralkine money: in R- and L-forms. For the same reason, a chiralkine system is not a “mutual credit” system. The R- and L-forms of chiralkine money are simply vectors indicating the unfulfilled parts of a contract.

Monopole money: single token money, including fiat money, such as pounds, yen, dollars, euros, etc.

Transaction: the barter (equitable exchange) of goods or services and left-handed money for an equal amount of right-handed money.

Currency exchange: the exchange of an amount of monopole money for an amount of chiralkine money in one of its two forms, left-handed or right-handed.

Chiralkine corporation: a legal person such as a company or partnership that is owned by one or more users.

It will be appreciated that an invention of this kind, which represents a paradigm shift in thinking in a field of technology, it is necessary to start out trying to describe features of the invention using terminology used to describe the features of conventionally-used technology. In a conventional monetary and property rights system, such term include bank, loan, credit, money, debt, property right, barter, profit, mortgage, lien, contract, mutual credit, value and so on. However, conveying a proper understanding of this invention requires the use of new terminology.

In another aspect, therefore, the present invention provides a chiralkine system for enabling equitable trade between users, which comprises an information transmission network having a register maintained by a recorder, said register being open to inspection by said users and containing records of chiralkine money and chiralkine property rights created under chiralkine contracts. In one embodiment, the register is an electronic register. The chiralkine system can be a closed system (in which chiralkine money is not interchangeable with monopole money). Alternatively, it can be an open system (in which each form of chiralkine money is interchangeable with monopole money).

### BRIEF DESCRIPTION OF THE DRAWINGS

FIG. 1 shows how conventional (monopole) money is used in a conventional (monopole) monetary system.

FIG. 2 shows how credit is used in a mutual credit system.

FIG. 3 shows how chiralkine money is used in accordance with the present invention.

FIGS. 4a, 4b, 4c and 4d show the steps in how conventional (monopole) money is created and redeemed by banks in a conventional (monopole) monetary system.

FIGS. 5a and 5b show how credit is created and redeemed in a mutual credit system.

FIGS. 6a and 6b show the steps in how chiralkine money is created and redeemed in accordance with the present invention.

Referring to the figures, FIG. 1 shows how money (M) is used in a monopole monetary system. A person (P1) purchases goods or services (G) from another person (P2) using money (M). This can be a cash transaction, or a bank transaction, in which case it is recorded in the accounts of P1 and P2 maintained by a bank. P1 provides an instruction to the bank to effect this.

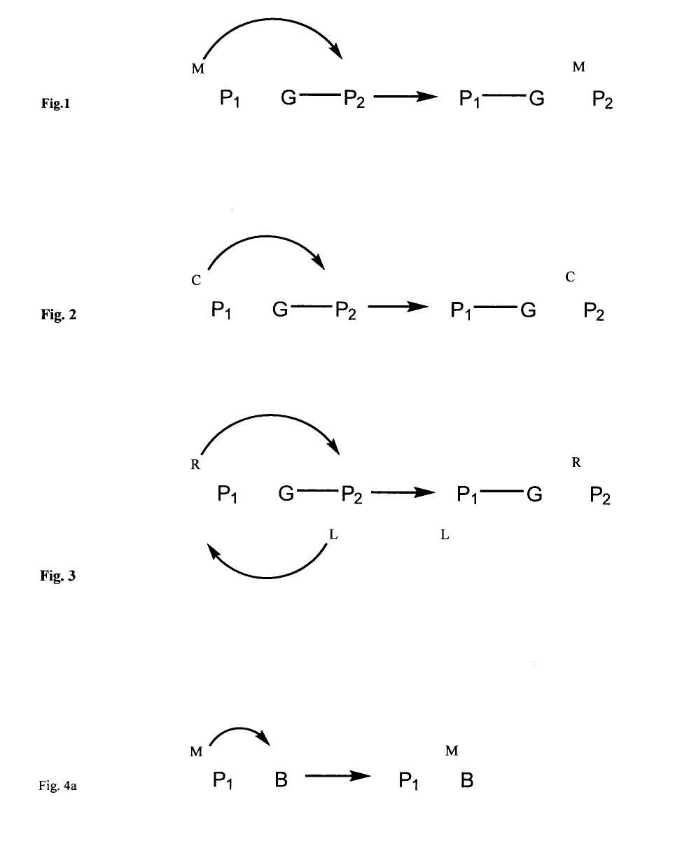

FIG. 2 shows how credit (C) is used in a mutual credit system. A person (P1) purchases goods or services (G) from another person (P2) using credit (C). In the accounts of P1 and P2 maintained by a recorder, the credit (C) is placed in the account of P2 and a debit is transferred to the account of P1, cancelling the credit, so that the balance is zero. P1 provides an instruction to the recorder to make these changes in the accounts.

FIG. 3 shows how chiralkine money is used in a chiralkine monetary system. A person (P1) purchases goods or services (G) from another person (P2). The bartering organisation registers that R-chiralkine money has been taken from the account of P1 and placed in the account of P2, and that L-chiralkine money has been taken from the account of P2 and placed in the account of P1. P1 and P2 both have to affirm to the bartering organisation that these changes are to be recorded in their accounts.

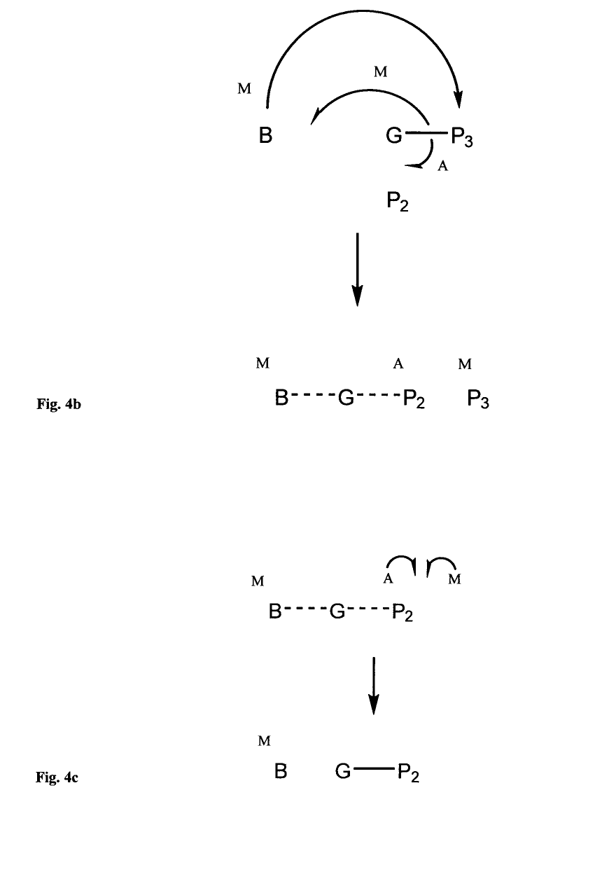

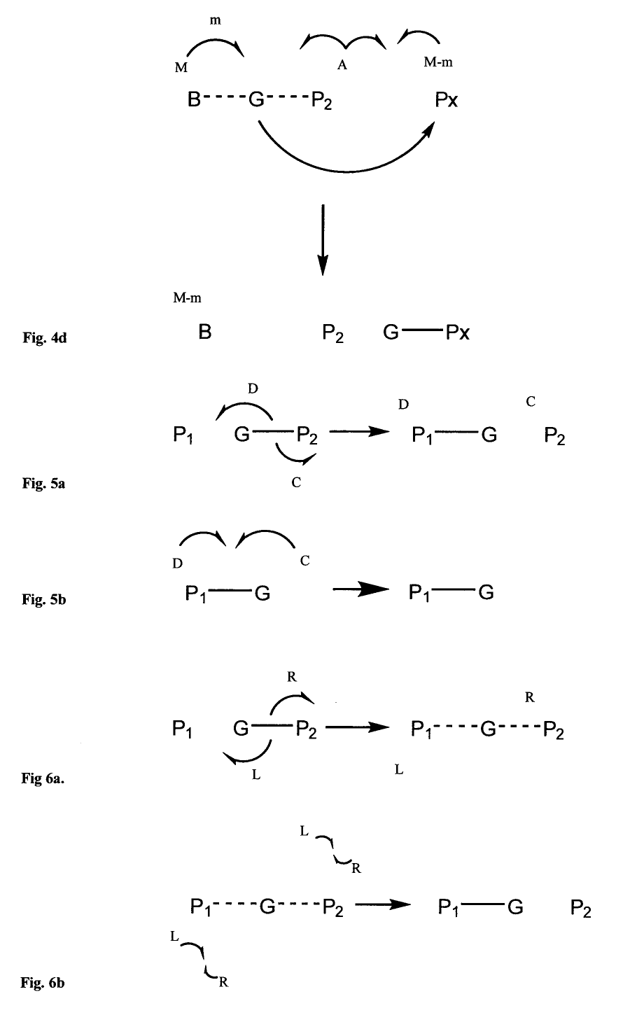

FIG. 4a shows the first step in the creation of monopole money by a bank (B). In this step, a person (P1) lends money (M) to the bank (B).

FIG. 4b shows the second step in the creation of monopole money by bank (B) to finance the purchase by a person (P2) of goods or services (G) from another person (P3). Usually, G is a monopole property right in real estate, such as a house. This kind of transaction is conducted under a kind of contract known a mortgage contract. The bank (B) lends the money (M) to P2, who then gives it outright to P3. This is shown by a double headed arrow direct from the bank to P3. P3 now owns the money (M). The symmetry in the monopole property right is now split, such the ownership of G is now in a transition state, both bank B and person P2 having an interest. This is represented by dotted lines connecting both B and P1 to G. It is common to speak of the bank having a lien on G. With this splitting of the property right, the bank (B) (out of nothing) creates money (M) and a kind of anti-money (A) known as debt. The bank assumes ownership of the money (M) and P2 the debt (A). The creation of money (M) and its opposite is represented by half-arrows, because the process involves symmetry breaking.

FIG. 4c shows the redemption of money in a monopole monetary system. Person P2, through sales of goods or services, earns money (M) which is used to pay off the debt (A) to bank (B). The money (M) and debt (A) cancel to zero. This is shown by two half arrows, as symmetry is now restored. The mortgage is now cancelled and P2 owns the monopole right in G. Note that in a monopole monetary system, P3 has no accountability for the money (M) created to finance the sale of G by P3 to P2. P3 can sell G for whatever price the bank is willing to create money for to cover.

Banks (in the current system) are commercial organisations that are run for a profit. They make a profit by charging people to whom they lend money more than they lend to them. This is known as interest. Thus, referring again to FIG. 4b, the bank would require that P2 repays more than the amount of M, say M+m. The payments to the bank are normally required to be paid in accordance with a schedule, known as a mortgage schedule. The schedule will indicate a completion date by when all payments will need to have been made. The extra money m received by the bank (after paying off any expenses of the bank) is its profit, and can be used by the bank to purchase assets. One kind of asset that is often bought by a bank is known as a government bond, sometimes known as a treasury or gilt. Politicians running a government (representative of a State) can arrange for the government to borrow money by issuing these government bonds, with an agreement to pay back the amount borrowed plus interest, backed up by a promise that the taxpayer will fund the repayment and interest. Banks can purchase these bonds. Thus, referring to FIG. 4b again, the bank (B) can use the additional money paid by P2 to purchase government bonds, and so enjoy an additional stream of income financed by the taxpayer.

FIG. 4d shows what happens if P2 does not repay its debt to bank B in accordance with the repayment schedule (is in default). Bank (B) sells the G to another person (Px) and uses the money received (M−m) to pay off whatever debt (A) of P2 that the proceeds of the sale will cover. If the amount of money received from the sale proceeds is insufficient to cover the debt, then the bank (B) will have to sell assets, such as the government bonds it purchased, or take a charge against the money (M) that it retains. If it does the latter, then it will have insufficient funds to repay its own lender P1 (see FIG. 4A), should P1 require repayment.

When a bank has many outstanding loans that its borrowers like P2 cannot repay, there is a problem. The lenders to the bank lose confidence, and demand that their money be repaid. This is known as a run on the bank. The bank is unable to sell all the properties on which it has mortgages, so is unable to repay its borrowers. If this situation happens with many banks at the same time, then a financial crisis results, such as is the case today. The process is known as deleveraging. In response to the present financial crisis, politicians (representing governments) have lent/given taxpayers' money (essentially a call against future taxes) to banks to make up some of their shortfall. This is known as recapitalisation of the banks. At the same time, central banks have created money (out of nothing, i.e. printed it) and used this to buy up government bonds, enabling banks to sell their holdings of government bonds (backed by the taxpayer). Referring to FIG. 4b again, the net effect of all of this is the creation (from nothing) and transfer of money (M) to the original vendor of G, P3, with the taxpayer accepting ultimate responsibility for the consequences of the creation of the money (M) used to finance the sale of G to P2. An unstoppable spiral takes hold, with widening wealth inequality, especially between indebted young and asset-rich old; as future taxpayers increasingly create money for the benefit of the P3s. The expanding national debt has a mirror opposite in the wealth of the P3s. There is no obvious way to unwind the position and restore symmetry to the system. The imbalances are inherent in the monetary system itself.

A second aspect of the present financial crisis, trade imbalances, can also be understood with reference to FIGS. 4a to 4d. The process starts with a loan of money from P1 to the bank (B). If P1 keeps on making and selling things and lending the money it receives to bank B rather than spending it, then a trade imbalance will result. It will also cause asset price bubbles, especially in real estate, as the bank B will lend the money it receives out in mortgages. If P1 and P2 are in different States, as where there is trade between States, then trade imbalances caused by one State running a trade surplus with respect to another can cause huge problems. Such is the case today as between China and the rest of the world, especially the US, or between Germany and the rest of the world, especially Greece. Again, there is no obvious way to unwind the position and restore symmetry to the system. The imbalances are inherent in the monetary system itself.

FIG. 5a shows how credit is created in a mutual credit system. P1, who has no credit, purchases G from P2. A debit entry is recorded in the account of P1 and a credit entry in the account of P2. The creation of the debit (D) and credit (C) are shown by two half arrows, as symmetry is broken. Note that in a mutual credit system, P2 has no accountability for the credit (C) created to finance the sale of G by P2 to P1. P2 could sell a pencil to P1 for the price of an automobile.

FIG. 5b shows how credit is redeemed in a mutual credit system. P1, through the sale of goods or services, acquires credit (C). This cancels the debit (D). The redemption is shown with two half arrows, as symmetry is restored. There is little a mutual credit organisation or its members can do to oblige credit to be redeemed. Thus, some people will accept goods or services from others, but not provide any themselves. The administrators need to identify these people and exclude them from continuing to trade with other members of the trading community.

FIG. 6a shows how chiralkine money is created in a chiralkine monetary system. P1 and P2 create chiralkine money to initiate the transfer of G from P2 to P1. To do this, they enter into a chiralkine contract. This contract has two parts, one part between P1 and P1 and the other between P1 and P2 jointly as a pair with a bartering organisation. The bartering organisation is not shown as it merely functions as a register. In accordance with the contract, the symmetry in the ownership of G is split, creating left- and right chiralkine ownerships in G. With this splitting in the symmetry of the ownership, P1 and P2 create (from nothing) chiralkine money in its two mirror forms: left and right chiralkine money. The chiralkine property rights and chiralkine money represent unfulfilled terms of the chiralkine contract. P1 receives the L-chiralkine money and the R-chiralkine property right. P2 receives the R-chiralkine money and the L-chiralkine property right. The ownership of G is now shown by two dotted lines, as G at once belongs (in a monopole sense) both to P1 and P2 and to neither of P1 and P2!

FIG. 6b shows how chiralkine money is redeemed. P1 sells some goods or service to another person, exchanging L-chiralkine money for R-chiralkine money. P2 purchases some goods or service from another person, exchanging R-chiralkine money for L-chiralkine money. When both have traded, the chiralkine money they hold is ready to be redeemed. The bartering organisation records that the money is redeemed, and that the R- and L-chiralkine rights resolve so that the R-right (owned by P1) becomes a monopole right.

Not shown in the figures is that the R- and L-chiralkine property rights are separately transferable and hence tradable. Although they are separately tradable, they will not trade for the same price as G, because it is uncertain whether the chiralkine contract will be fulfilled by each of P1 and P2 acting in accordance with their agreement with one another (in which case the monopole right will go to the holder of the R-chiralkine right, P1) or one or both of P1 and P2 will be in default, so the other member of the pair will have to make good on the contract between the pair and the bartering organisation. In the latter case the way in which the members of the pair have to make good on the contract determines who acquires the monopole right in G.

The determination of which one of the holders of the L- and R-chiralkine property rights acquires the monopole right is analogous to the way in which mortgages work. However, in a chiralkine system, both of the parties who have created chiralkine money are held to account, so it matters which of them is in default. Thus, at the completion of a chiralkine contract, if one of the trading pair is in default with respect to the other, the ownership of the monopole right is decided and registered by the bartering organisation in favour of the member of the trading pair that would be required to remedy the default. If both are in default, the balance of R- and L-chiralkine money between them determines the overall outcome (i.e. which is most in default). If there is an excess of one form of R- and L-chiralkine money between them, it means that there is a trade imbalance between the pair and other users. Chiralkine money can only be redeemed when there is a trade balance (equal amounts of R- and L- are required for redemption). This is where concepts from quantum theory, in particular of spin systems and entanglement find application on monetary and property rights systems. When L- and R-chiralkine property rights collapse into a monopole right, there are two possible outcomes, which are determined by the relative positions of the members of the trading pair in R- and L-chiralkine money.

The following Table 1 summarises the outcomes registered by the bartering organisation for the closure of chiralkine property rights, depending on which party if any is in default of that part of the chiralkine contract that is between the two of them. The interests of the users of the bartering organisation are privileged over the interests of the members of the pair of people that create chiralkine money. The bartering organisation has no responsibility for determining the liabilities of members one to the other in a defaulting pair, nor of making a determination of appropriate compensation. This is a matter that can only be addressed independently, if necessary through a court of law. The position of the bartering organisation is symmetric as between the two members of the pair.

TABLE 1
Outcomes where P1 has started out with an R-chiralkine ownership
right and L-chiralkine money, and P2 has started out with an
L-chiralkine ownership right and R-chiralkine money.

| Action | Outcome |
|---|---|
| All trades completed | Chiralkine money redeemed. Owner of |
| in accordance with | R-chiralkine right (P1 or successor in title) |
| contract. | registered as owner of monopole right. |
| No Trades were | Revert to original state. Chiralkine money |
| done. P1 and P2 | redeemed. Owner of L-chiralkine right (P2 or |
| both in default. | successor in title) registered as owner of |
| | monopole right |
| P2 in default. | Purchase required to restore balance in |
| | R- and L-chiralkine money before redemption |
| | can take place. P1 can make purchase to complete |
| | contract. Owner of R-chiralkine right (P1 or |
| | successor in title) then registered as owner |
| | of monopole right. In effect, bartering |
| | organisation registers gift from P2 to P1. |
| P1 in default. | Sale required to restore balance in R- and |
| | L-chiralkine money before redemption can take |
| | place. P2 can make sale to complete contract. |
| | Owner of L-chiralkine right (P2 or successor in |
| | title) then registered as owner of monopole right. |
| One or both | If there is an excess of R between them, P2 |
| of P1 and P2 | is most in default. If there is an excess of L, |
| has some R and | P1 is most in default. P1 and P2 can co-operate to |
| some L money, so | complete the contract by making one or more trades |
| one or both | that amount to a net sale. Ownership of monopole |
| are in default. | right registered according to who was most in |
| | default. |

In a closed system, both members of a trading pair will have an amount of chiralkine money at least equal to the amount that they have created. In an open system, however, one or both of them could subsequently have entered into a currency exchange agreement such that they have exchanged L- or R-chiralkine money for monopole money, as described hereinafter. It is possible that at the completion date of their chiralkine contract, neither has any chiralkine money remaining. The created chiralkine money would now be in the accounts of other users. This corresponds to the case in Table 1 where both P1 and P2 are in default, and no trades have been done, so the bartering organisation would register the owner of the L-chiralkine right (P2 or successor in title) as the owner of the monopole right. However, in an open system, the ability of the members of trading pairs to exchange monopole money for L- or R-chiralkine money provides an alternative way of avoiding default.

If the non-defaulting member of a pair does not remedy the default of the other pair member, then the trading pair is in default with respect to its part of the contract with the bartering organisation. The bartering organisation collapses any chiralkine rights into monopole rights and registers them to one pair member identified as described above. The bartering organisation can sanction both pair members equally, for example by freezing their accounts in chiralkine money or suspending/excluding them from membership of the bartering organisation. These sanctions can be published.

When a trading pair is in default, the balance in the distribution of R- and L-chiralkine money as between the trading pair and the others needs to be restored, both in amount and symmetry, so it as if the chiralkine contract has been closed properly. This can be achieved by making some form of equitable distribution across the trading users. Normally trading pairs in default will have a surplus of L over R chiralkine money in their accounts (have received more goods and services from the other members than they have provided), so the other users will need to make good by receiving L-chiralkine money and giving R. The bartering organisation can handle this as follows. It can, periodically, identify the trading pairs in default and assess in the aggregate the amount of L- or R-chiralkine money these pairs would need to exchange with the other members of the bartering organisation in order for the money created by them to be redeemed. The bartering organisation can then open holding accounts in R- and L-chiralkine money and transfer the balances from the accounts in default to these. It can then issue a demand on users to exchange chiralkine money with it (R- for L-), not necessarily in equal amounts but sufficient to enable it to redeem the chiralkine money in the holding accounts. Equitable distribution could be effected, for example, by means of periodic calls levied on all users as a condition for continued membership. This could cause serious hardship in individual cases. Levying it as a percentage of the amount of chiralkine money in the account of a user is one alternative, but would violate the symmetry of equitable trade and hence be inequitable. Levying it as a percentage of the value of users' monopole rights in real assets, like a tax, would be another alternative that would not violate symmetry.

It will be appreciated that the resolution of defaults in a chiralkine system, although on the face of it more complex that the resolution of defaults in a conventional monetary system, is advantageous. Thus defaults cannot accumulate in the system, but are kept isolated at the level of trading pairs and are promptly resolved. In a conventional system, mortgage-backed borrowers from banks can accumulate huge debts, which can lead to sudden financial crises when taxpayers need to bail out the banks. This creates huge shocks to the economy, and unfairly burdens working (especially young) people with the costs of the bailout.

A non-defaulting pair member that acts to make good on the default of the other pair member may, after the chiralkine money created by the pair has been redeemed, have trading privileges restored by the bartering organisation. Thus, provided that individual members make good on the obligations that they assume in pairs, they may still be permitted to trade. A user's reputation as a good pair member is very important to them, and to the credibility of the chiralkine money that they create.

The closing down of a bartering organisation according to the invention can be effected as follows. If possible, a period of notice is provided during which users can seek to bring their chiralkine contracts to completion. Thereafter, monopole rights are registered according to the balances in the accounts of trading pair members, just like in the case of defaults.

The following describes how the bartering system according to the invention works using chiralkine money as described hereinabove.

The means for creating user agreements between the bartering organisation and users can be virtual.

A person wishing to enter into a user agreement with a bartering organisation will normally apply online. The terms of a standard user agreement can be displayed, and accepted or rejected by clicking on a virtual box on a computer screen. As part of their process for handling applications for acceptance of applicants as users, a bartering organisation can request information to verify the identity of the applicant, and record personal information, such as the prospective user's postal address. It can also perform checks to identify any reasons for rejecting the application, for example a previous history of non-compliance with agreements relating to the bartering organisation or other organisation. Accordingly, the bartering organisation can maintain a database of users. It can assign a unique identifying number to a user, which can be used to link the user to all matters pertaining to that user. It could be a bar code or a quick response code.

The means for implementing user agreements comprises technical features that together enable users to use the bartering system to barter for goods and services.

The means for representing chiralkine money can be real, as in a coin or paper note (cash), or virtual, as can be displayed on a computer screen. A coin or note is preferably configured so as to be difficult to forge, for example like monopole coins and banknotes. The representation can indicate whether the chiralkine money is left-handed or right-handed, and what value it is. For example, chiralkine money of value 5 can be denoted 5 LCU (5 left-handed chiralkine units) or 5 RCU (5-right-handed chiralkine units). Once a bartering organisation has entered into a user agreement with a user, it can set up an electronic account in chiralkine money (right- and left-handed) for the user. The user can access this account online, and direct payments in right- and left-handed chiralkine money from the account to the account of another user. Access to the account may be protected by security, for example encryption (such as using a digital certificate). A user may be provided with a special card that evidences the identity of the user and/or a secret password (for example a smart card, such as a SIM card used in cellular phones, including smartphones). Accordingly in one embodiment, the system according to the invention is adapted such that users can communicate with the bartering organisation using a special card that evidences the identity of the user and/or a secret password. Money can be moved between user accounts whenever bartering agreements between users are implemented, and can be placed in or removed from accounts by the bartering organisation as it implements a credit agreement or if chiralkine money in the form of cash is withdrawn or deposited.

In one embodiment of the invention, the means for representing chiralkine money is purely electronic. Cash is not used in the system. Users are then unable to engage in transactions without the bartering organisation effecting changes in both left-handed and right-handed money in their electronic accounts. Thus, for example, a user could not improperly exchange goods or services for one form of chiralkine money without giving the other form of chiralkine money in return. This is an important difference with the split tally stick system of medieval times. In a chiralkine economy, taxation would involve a taxpayer paying right-handed chiralkine money to the state in return for left-handed money. Servants of the state would need to pay left-handed chiralkine money to the state in return for their salary in right-handed chiralkine money. Thus, the state would have to live within its means. One can speculate that in a chiralkine economy, the role of the state would be much reduced compared with that in a fiat money economy. Thus, users might collectively barter with individuals or chiralkine corporations for the provision of public services, such as fire services, police, healthcare and education.

It will be appreciated that a property right in something is different from the thing itself. It is an imaginary concept. You can own an apple and you can eat an apple, but you cannot eat a property right, because it has no physical form. You can transfer title in a property right in something to another without changing the thing itself.

The concept of left- and right-handed property rights is highly abstract. They are entangled states. They are created when left- and right-handed money is created at the start of the implementation of a credit (chiralkine) agreement and they collapse together to form a monopole property right when left- and right-handed money is recombined as the implementation of a credit agreement is concluded. They form the basis for the ‘value’ of chiralkine money, like gold used to do for monopole money when the gold standard was used. They hold both parties to a barter agreement to account until both have been satisfied: both have provided and received goods or services of value equal to the amount of the chiralkine money they have created. If all users of a bartering organisation have exchanged goods or services, then there will be only monopole property rights remaining in existence, and no chiralkine money.

The means for representing monopole property rights can be virtual, as in a field in a database, such that they can be displayed on a computer screen. An electronic register of property rights can be maintained by the bartering organisation, linking descriptions of goods or services to property rights and the users that own them.

The means for representing chiralkine property rights can be virtual, such that they can be displayed on a computer screen. An electronic register of chiralkine property rights can be maintained by the bartering organisation, linking descriptions of goods or services to property rights and the paired users that own them. The representation can indicate whether the chiralkine property right is right-handed or left-handed.

The web-based bartering market can comprise a field for displaying a representation of goods or services to be bartered (the Subject), for example a written description or a photograph. It can also comprise a field for displaying prices, including asking prices and bids (offers). The market can also comprise a field for displaying whether a user intends to pay with existing savings or enter into a credit agreement. It can also comprise a field displaying a time limit for completion of bids. It can also comprise a field for displaying the terms agreed in a bartering transaction agreement (the price agreed and the arrangements for implementation such as the shipping of goods and the transfer of chiralkine money between users' accounts).

The bartering market can further comprise a database of prices from past transactions, which can be used as a reference for pricing goods or services to be bartered and, when credit needs to be created, for valuing goods or services to ensure that an agreed price is realistic. This assures that the value being represented by chiralkine money is soundly based.

The bartering organisation can provide the subject with a unique identifying number (which could be a bar code or quick response code), which can then be used to link the subject to all contracts and users through their unique identifying numbers. Objects can be marked with this number to identify them. The number can also be used to track the transportation of subjects between users, for example when a postal service, courier or other commercial carrier is used.

The provision of a unique identifying number to a subject can be advantageous where a government levies taxes based upon the value of assets (monopole rights) owned by a person. This would be most practical if the number were to include some code that identifies asset types upon which taxation is to be based, for example real estate or automobiles. A search of a bartering organisation register for subjects identified by that code could readily yield a listing of all such monopole rights owned by a person, together with a record of the amount in chiralkine money for which the right was traded.

Taxation breaks the symmetry of equitable trade by imposing a fictional obligation on one to fund the purchase of another. In effect, a person who goes without a subject for the benefit of another is penalised.

Properly administered, taxation and public spending can elicit highly advantageous collaborative behaviour: behaviour that cannot emerge through simple pairwise trades. However, the current monetary systems enable the opaque creation of money by banks to cover the opaque unfunded commitments of politicians, with future taxpayers being liable for making good on the consequences. Tax systems under such monetary systems are often highly complex, indeed undecipherable to ordinary people, and have no clear equitable principles underlying them.

Chiralkine systems are based upon equitable trade. Unlike in a conventional monetary system where money represents a store of value, the two forms of chiralkine money are not stores of value, but merely vectors indicating the unfulfilled parts of contracts. The balances in the two forms of chiralkine money in the accounts of members of a trading pair provide a clear numerical measure for others to gauge whether they are standing behind the contract through which they have created the money. The amount of chiralkine money in circulation at a given time is simply a representation of the totality of incomplete contracts in the bartering community. There is no profit to be made in a transaction involving the exchange of chiralkine money.

It is tempting to consider breaking the symmetry such that tax is levied (in R-chiralkine money for L) on a party receiving R-chiralkine money for left. However, this would be to misunderstand chiralkine money and fall into the trap of equating R-chiralkine money with conventional money. It is also tempting to empower an agency or those charged with responsibility for procuring public services to create more chiralkine money than is required to cover the costs of administering equitable trades, but this would again be to readmit the risks of unfunded spending commitments being made by governments under the current system. Taxation needs to be based upon the real assets (monopole rights) accumulated by people, especially real estate (land). Real assets represent a store of value that people can accumulate in a chiralkine economy. The store will start out empty during childhood, fill during mid-adulthood and empty out during old age, as real assets are traded out in effect to pay for life-sustaining goods and services. Tax can be raised by assessing the value of the real assets of a person and creating chiralkine money in L- and R-forms in an amount of a percentage of that value, providing the person with the L-form and the State with the R-form and indicating a completion date by which the person and the State must provide the amount of chiralkine money in R- and L-form for redemption. This form of taxation is essentially that of the medieval tally stick system.

The means for creating credit agreements (chiralkine contracts) between the bartering organisation and users thereof subject to a barter transaction agreement can be virtual, such as can be displayed on a screen. It can comprise a field containing a standard agreement that users can accept or reject by clicking on a box. An example of such an agreement is provided in Illustration 1 hereinafter. It can further comprise a means for checking the credit-worthiness (reputations) of users (their past history) and a valuation of the goods or services to be bartered, for example by checking against price records in a database of past transactions.

The credit agreement has two parts, one part between first and second people in a trading pair that are creating chiralkine money, and a second part between the pair as a whole and the bartering organisation (representing all its users). The two parts in this special form of contract, which is referred to herein as a ‘chiralkine contract’, are orthogonal. The second part holds the first and second people jointly to account to all users of the bartering organisation for the chiralkine money that they create. If one of them is in default, the other must make good, so that the contract is completed. It is through the orthogonal relationship of the two parts of the contract that symmetry is broken in ownership of goods or services being traded, enabling the creation of chiralkine money and chiralkine property rights.

The implementation of a credit agreement requires the creation of chiralkine money in equal amounts of left and right-handed chiralkine money to the amount of the price agreed in the barter transaction agreement. It also requires the creation of left and right-handed chiralkine property rights in the goods or service being provided. The prospective purchaser of the goods or services receives the right-handed chiralkine property right, and left-handed chiralkine money, and the prospective vendor receives the left-handed chiralkine property right, and right-handed chiralkine money. The left- and right handed chiralkine money is credited to (recorded in) the accounts of the users. The ownership of the right- and left-handed property rights is recorded in a register of property rights. The credit agreement provides a schedule for the repayment (redemption) of left-handed chiralkine money by the prospective vendor (who now has right-handed money in their account) and right-handed money by the prospective purchaser (who now has left-handed money in their account). When the bartering organisation has been repaid (is in a position to redeem) all that it is owed by both users, the left- and right chiralkine money is destroyed (cancelled out), and the left and right chiralkine property rights are collapsed into a monopole property right. Entries are made in the property register to the effect that the chiralkine property rights have been collapsed and the monopole property right is now owned by the purchaser.

In certain cases, chiralkine money can be created and redeemed very quickly, before any goods change hands or services are performed. Thus, chiralkine money couples barter transactions together, enabling paired users who create chiralkine money to each simultaneously enter into barter transaction agreements with other users to trade in and trade out. This is particularly advantageous in transactions involving real estate.

The terms of the credit agreement ensure that the prospective vendor has to spend the right-handed chiralkine money to obtain left-handed chiralkine money, and the prospective purchaser has to sell some goods or service to obtain right-handed chiralkine money. It forces the completion of the original barter. When the original prospective vendor has purchased something that person wants to the value of the original barter, and the prospective purchaser has sold something to the value of the original barter, then the barter will be completed.

The bartering organisation can provide a unique identifying number to the credit agreement (chiralkine contract), which can then be associated with identifying numbers of all users and an identifying number of the subject to which it relates.

The means for implementing a bartering transaction agreement can comprise means for transferring chiralkine money between users' accounts and means for confirming shipping of goods from user to user or completion of a service by one user for another.

The bartering organisation can operate as a closed or an open system. In a closed system, monopole (real) money cannot be exchanged for chiralkine money. In an open system, monopole money can be exchanged by users for chiralkine money. The exchange rates for monopole money with left- and with right-handed money can be fixed by the bartering organisation, or determined by barter. When they are determined by barter, they can fluctuate, depending on the balance of trade in monopole money between the bartering organisation and the outside world. A trade deficit with the outside world would result in an increase of the value of left-handed money in monopole money, because importers would need to purchase it in order to sell into the bartering organisation. Left- and right-handed money always exists in equal amounts, so a net importer would need to buy a surplus of left-handed money and sell a surplus of right handed money.

Accordingly, in one embodiment of the invention, the system is an open system in which the means for implementing user agreements further comprises
(ix) means for representing monopole money;
(x) means for creating currency exchange agreements for exchanging monopole money for chiralkine money; and
(xi) means for implementing currency exchange agreements.

In another embodiment of the present invention, the means for implementing user agreements further comprises:
(xii) means for representing a register of user property rights.

The register may record monopole and chiralkine property rights against the name of the user(s) that owns them.

The interchangeability of monopole money with each form of chiralkine money is an extraordinary aspect of the present invention, but it results from the fact that monopole money has two functions, not one. It can behave like the R-form of chiralkine money in some situations and like the L-form of chiralkine money in others. In other words, the something that is monopole money is actually one something to buy with and another something to sell for, and at any given moment in time these two somethings are not the same. When money changes hands, different information flows in one direction than the other. It is information about the balance of trade in a trading community, and it is lost whenever debits and credits are allowed to cancel. Requiring that monopole money can only be traded with L-chiralkine money for R-chiralkine money, as is required for the trading of goods and services, would not work. It has to be exchangeable with both. This is why the conventional understanding of money is flawed, and why the present monopole monetary system yields all the problems that it does.

Users in systems that are open (in which monopole money can be traded for chiralkine money) can resolve trade imbalances between users internally through users converting chiralkine money into and out of monopole money. This is particularly the case where one or both parties to a chiralkine contract are in default and need to acquire one or other form of chiralkine money, or where a system needs to be shut down and the positions of users resolved in monopole money. However, they are then exposed to the risks of trading using a monopole monetary system!

It will be appreciated that the bartering organisation requires resources in order to be able to operate. It could be run as a community or charity project, based upon donations and the work of volunteers. However, it could be funded by selling advertising space for a fee, or by charging an administrative fee when users enter into agreements with it and or other users. A fee could be charged in monopole or chiralkine money. In one embodiment, a user and the bartering organisation enter into a chiralkine contract, in which the user receives L-chiralkine money and the bartering organisation receives R-chiralkine money, the contract providing that when the contract is completed and the money redeemed, the user must provide R-chiralkine money and the bartering organisation L-chiralkine money.

Accordingly, in yet another embodiment of the invention, the bartering system further comprises:
(c) means for creating advertising agreements between said bartering organisation and advertisers; and
(d) means for implementing advertising agreements.

The means for implementing advertising agreements can comprise advertising space on a website of the bartering organisation, or communicated through other means such as by telephone.

A system based upon left- and right handed money would require apparatuses adapted to handle money in both forms, such as cash dispensers, vending machines, etc. According to another aspect, therefore, the present invention provides an apparatus adapted for use with left and right handed money, selected from:
a bank card, comprising a machine readable identification code, said card being adapted to handle transactions in left- and right-handed money;
a cash machine adapted to dispense left- and right-handed money (cash);
a cash register adapted to handle and record transactions in left- and right-handed money (cash);
a vending machine adapted to receive money (cash) in one of right- and left-handed forms and dispense it in the other; and
an apparatus for use by a bank, comprising left- and right handed money and a computer programmed to maintain records of transactions in left and right-handed money.

In one embodiment, said apparatus is selected from:
a bank card, comprising a machine readable identification code, said card being adapted to handle transactions in left- and right-handed money; and
an apparatus for use by a bank, comprising left- and right-handed money and a computer programmed to maintain records of transactions in left and right-handed money. In another embodiment, said apparatus is a bank card, comprising a machine readable identification code, said card being a SIM card in a mobile device, said device adapting said card to handle transactions in left- and right-handed money, for example a cell phone (mobile phone).

According to another aspect, the present invention provides an apparatus for use by a lawyer, comprising documents representing left- and right-handed property rights and a computer programmed to maintain records of transactions in left and right-handed property rights.

In another embodiment, the system according to the invention is adapted such that users can communicate with the bartering organisation using an apparatus having GPS (global satellite positioning) technology. The information provided by this technology can be used to help reduce the carbon footprint of users, by enabling users to optimise trade pairings based upon the distances that goods or services are provided across.

The means for implementing any agreement can comprise sanctions against a user or pair of users in default. For example, the name of the user or names of users in a pair of users may be published on the web-site of the bartering organisation. An account may be frozen or a user may be refused further access to the services of the bartering organisation.

In another aspect, the present invention provides a method of using a system as defined hereinabove, in which said bartering organisation enters into a user agreement with a chiralkine corporation.

In another embodiment a user is a chiralkine corporation owned by one or more users. The users may, for example, own monopole rights in shares in the chiralkine corporation. To the extent that the chiralkine corporation owns assets, such as monopole property rights, the users own a share in those assets. The users may have complimentary skills, such as a plumber, accountant, IT expert and lawyer who together can produce goods or provide services for bartering with other users of the bartering organisation. The experts may work under a collaboration agreement, for example as described in United States patent application publication number US 20110082805A1.

In another embodiment, the bartering organisation can be an e-commerce business or an m-commerce business. In one embodiment, the bartering organisation is a telecommunications business. In another embodiment, it is a social media business. Examples of social media businesses include FACEBOOK, GOOGLE, LINKEDIN, YAHOO and TWITTER. In yet another embodiment it is an internet search engine business.

It will be appreciated that the invention is all about equitable trade, which means that different parties are involved, each of which can own property. Accordingly, different technical components of the bartering system can be owned by different parties. The bartering system can be thought of as being made up of a complementary pair of apparatuses adapted to communicate each with the other, one pair member being for the bartering organisation and the other for a user. These apparatuses can be made and sold separately.

According to another aspect, therefore, the present invention provides an apparatus selected from a complementary pair of apparatuses capable of communicating each with the other and that together constitute a web-based bartering system as described hereinabove, one being for a bartering organisation and the other for a user. In one embodiment, the apparatus is an e-commerce or an m-commerce communications device for a user. Examples of such devices have been described hereinabove, and include telecommunications devices such as cell phones.

The following Illustration and Examples illustrate the invention.

### Illustration 1: CHIRALKINE CONTRACT

In the first part, this contract is made between:
. . . (First-named Person)
   and
. . . (Second-named Person)
   together referred to as Trading Pair; and
   in the second part between
Trading Pair
   and
. . .
(Bartering Organisation)
   Whereas the First-named Person wishes to provide to the Second-named Person and the Second-named Person wishes to receive from the First-named Person the following subject:
. . . (Subject)
   equivalent in an amount in units of chiralkine money of:
. . . (Amount)
   and First-named Person and Second-named Person wish to trade subsequently with Members of the Bartering Organisation such that each has both provided and received subjects of amount at least equal to the Amount on or before the Completion Date of
. . . (Completion Date)
   whereas the Trading Pair wishes to create chiralkine money (R and L) in units equal to the Amount, for a period of time not to exceed the Completion Date and then redeem it; and
   whereas the Bartering Organisation is willing to maintain a file for this contract and a register of transactions thereunder for inspection by Members of the Bartering Organisation; and
   whereas the creation of the chiralkine money requires that the ownership of the Subject be transitioned through a state of chiralkine ownership having separately tradable L- and R-forms for the duration of the existence of the chiralkine money;
   Now therefore it is agreed as follows:
   between the Bartering Organisation and the Trading Pair that:
   the Bartering Organisation will assign a contract number to this contract and associated with the contract number, maintain, open for inspection by its Members:
   a file for this contract containing a copy of this contract and any other documents relating thereto; and
   a register containing information identifying the First-named Person, the Second-named Person, the Subject, the Amount, the Completion Date, the creation and redemption of chiralkine money by the Trading Pair, the creation and redemption of chiralkine ownership in the Subject, each ownership in the Subject, the outstanding balances in R- and L-chiralkine money of the First-named Person and Second-named Person under this contract, and the current balances in R- and L-chiralkine money held by the First-named Person and Second-named Person;
   the Trading Pair will create, trade using and redeem chiralkine money in accordance with the agreement between the First-named Person and the Second-named Person, will provide all documents and information required to be filed or registered by the Bartering Organisation in accordance with this contract, and will check and approve the file and register of the Bartering Organisation for accuracy and completeness; and
   between the First-named Person and the Second-named Person that:
   the First-named Person and the Second-named Person will create chiralkine money in R- and L-forms, each in the amount of the Amount, and chiralkine ownerships in the Subject, each in L- and R-forms,
   they will separate the chiralkine money and ownerships in the Subject so that the Second-named Person receives the R-chiralkine ownership in the Subject and L-chiralkine money and the First-named Person receives the L-chiralkine ownership in the Subject and R-chiralkine money;
   each of the First-named Person and the Second-named Person will trade with Members of the Bartering Community so as to exchange an amount at least equal to the Amount of the form of chiralkine money they have received with its opposite;
   on or before the Completion Date, the First-named Person will provide L-chiralkine money in the amount of the Amount and the Second-named Person will provide R-chiralkine money in the amount of the Amount, and these forms of chiralkine money will be combined and so be redeemed; and
   upon redemption of the chiralkine money, the ownership of the Subject is restored, fully transferred to the owner at that time of the R-chiralkine ownership in the Subject.

This contract is subject to the standard terms and conditions of the Bartering Organisation, which provide for outcomes in the event of defaults by one or more of the parties to this contract.

### EXAMPLE 1

Person P1, Person P2 and Person P3 wish to use the services of a bartering organisation. They apply online to each enter into user agreements with it. The bartering organisation checks whether there is any reason to exclude P1, P2 or P3, for example because they are in default of a prior agreement with the bartering organisation or any other organisation. Finding no objections, the bartering organisation enters into separate user agreements with each of P1, P2 and P3. The bartering organisation opens accounts in left- and right-handed chiralkine money for each of P1, P2 and P3. The balance on each account is zero.

P1 wishes to offer a monopole or chiralkine property right in goods G1 for barter. A description and/or image of G1 is provided on a web-based bartering market maintained by the bartering organisation. A suggested price in chiralkine money is provided. P2 and P3 both bid for G1. The bid of P2 is accepted. Accordingly, P1 and P2 enter into a barter transaction agreement. Each of P1 and P2 needs chiralkine money in order for the barter transaction agreement to be implemented. Neither has any in their account.

P1 and P2 seek to enter into a credit agreement (chiralkine contract) with the bartering organisation. The bartering organisation checks the agreed price for G1 against historical transaction records and confirms that this is realistic. The bartering organisation then enters into a credit agreement with P1 and P2. It (strictly the contract) then creates both left and right-handed forms of chiralkine property rights in G1, and the requisite amounts of left- and right-handed forms of chiralkine money. The money is placed in the accounts maintained by the bartering organisation on behalf of P1 and P2, left-handed for P1 and right-handed for P2.

P1 now transfers ownership of the right-handed property right to P2, and the bartering organisation registers this. Left-handed money is transferred from the account of P1 to P2. P2 transfers ownership of the left-handed chiralkine property right to P1 and the bartering organisation registers this. Right-handed chiralkine money is transferred from the account of P2 to P1. Now P1 has right-handed chiralkine money, but needs to repay (present for redemption) the bartering organisation in left-handed chiralkine money. P2 has left-handed chiralkine money, but needs to repay (present for redemption) the bartering organisation in right-handed chiralkine money. The only way for P1 to obtain this left-handed chiralkine money is to spend the right-handed chiralkine money in a bartering transaction for something. P2 has left handed chiralkine money, but needs to repay the bartering organisation in right-handed chiralkine money. The only way to obtain this right-handed chiralkine money is for P2 to sell something in a bartering transaction.

P2 wishes to offer a monopole property right in goods G2 for barter. A description and or image of G2 is provided on a web-based bartering market maintained by the bartering organisation. A suggested price in chiralkine money is provided. P3 bids for G2. The bid is accepted. Accordingly, P2 and P3 enter into a barter transaction agreement.

P3 needs right-handed chiralkine money in order for the barter transaction agreement to be implemented. P3 has none in P3's account. P3 has monopole money. P3 wishes to enter into a currency exchange agreement for exchanging monopole money for right handed chiralkine money.

A description of the proposed exchange is provided on the web-based bartering market maintained by the bartering organisation. A suggested price in right-handed chiralkine money for the monopole money is provided. P4 and P5 both bid for it. The bid of P5 is accepted. Accordingly, P3 and P5 enter into a currency exchange agreement. The currency exchange agreement is implemented. P3 now has the right-handed chiralkine money in P3's account and P5 has the monopole money. The barter transaction agreement between P2 and P3 is then implemented. Now P2 has the right-handed chiralkine money in P2's account. P3 has the corresponding amount of left-handed chiralkine money in P3's account and the goods G2. P2 uses some of the right-handed chiralkine money to pay off P2's debt to the bartering organisation in respect of the contract for G1.

Eventually, after several bartering transaction agreements have been implemented, the debts of P1 and P2 to the bartering organisation in left- and right-handed chiralkine money have been paid back (R and L chiralkine money have been presented for redemption). The chiralkine money is then destroyed, and the left- and right-handed property rights in the goods G1 are collapsed into a monopole property right owned by P2. This is all recorded in the register of user property rights maintained by the bartering organisation.

### EXAMPLE 2

### Use of Left- and Right-Handed Money and Property Rights in Commerce

This example is taken from the priority document that first contained it, PCT/GB2011/001583. As originally written, the term “bank” was used to denote what is now more properly referred to in this specification as the bartering organisation or recorder. The original term “bank” has been retained in this example. The example in the priority document also erroneously described the bank as having liens. This has been corrected below, with deleted text being shown in square brackets [ . . . ]. The “bank” is only a recorder that maintains a register. The created money is a pair of vectors, not a store of value.

A property developer P purchases a plot of land on which there is a house and a garden. P forms a new plot by dividing off part of the garden and builds a house on this. Person Q wishes to buy the new house. P and Q agree that Q may purchase the house from P for 100,000 currency units. In order for this transaction to take place, left- and right handed property rights in the new plot must be created. Lawyer S, acting for P, creates two documents consisting of left- and right-handed title deeds to the new plot. These are reviewed by Lawyer R acting for Q. S and R both save electronic copies of the documents on their respective computer systems, and also enter the names of P and Q into their respective computerised docketing systems that record the ownership of left- and right-handed property rights. In order to finance the transaction, P and Q both borrow money from Bank B. Both P and Q have accounts at B, in both LCU and RCU. Each account has one account number for both LCU and RCU. B appraises the house and agrees that it is worth 100,000 currency units. B creates (from nothing) 100,000 left-handed currency units (LCU) and 100,000 right-handed currency units (LCU). It lends the 100,000 LCU to P and the 100,000 RCU to Q. The creation of the money is recorded in the financial accounts of the bank. B enters a debit of 100,000 LCU against the account of P and 100,000 RCU against the account of Q in its computer system. The money is transferred electronically to the client bank accounts of S and R respectively. S and R arrange for 100,000 LCU to be transferred to the bank account of Q and 100,000 RCU to be transferred to the bank account of P. B records these transactions in its computer system. The bank account of P now shows a credit of 100,000 RCU, whereas that of Q now shows a credit of 100,000 LCU. S and R now apply to register the creation and current ownership of the property rights with the government real estate registry. Since the property rights have been used as security for the loans, this fact is recorded by the registry alongside the ownership of the left-handed property right by P and the right-handed property right by Q. [The left-handed property right is secured on the RCU deposited in the bank account of P, the balance of which the bank B holds until the equivalent amount in LCU has been repaid off the loan.] P and Q now pay their lawyers for the services rendered to them. P and S each use their respective bank cards, each card comprising a machine readable identification code and being adapted to handle transactions in left- and right-handed money. 1,000 RCU is debited from the bank account of P and credited to the bank account of S. 1,000 LCU is debited from the bank account of S and credited to the bank account of P. Q and R use cash, Q giving R 900 RCU and receiving 900 LCU in return. P now needs some more cash. P withdraws 600 RCU and 50 LCU in banknotes from its bank account using the bankcard and a cash machine adapted to dispense left- and right-handed money. The bank B adjusts the balances of RCU and LCU in P's bank account accordingly. P then purchases a bottle of a drink for 2 RCU from a vending machine. P inserts a bank note for 5 RCU into the vending machine and receives in return the bottle of drink, 3 RCU in coins and 2 LCU in coins. Next P goes into a shop and buys a new television set for 500 RCU. P pays for this in cash. P receives the television set and 500 LCU. The cashier for the shop uses a cash register containing cash in both left- and right-handed money to receive the 500 RCU and dispense the 500 LCU. The cash register records the transaction and prints a receipt showing the transaction. P deposits the 500 LCU in its bank account, and directs that this be used to reduce the balance on its loan used to finance the sale of the property to Q. The bank cannot lend out this money. It can only create money secured on left- and right-handed property rights, and can only lend money created by it or deposited with it. Q gets a job. Q borrows 3000 LCU from the bank, giving this to Q's employer in return for 3000 RCU. Q deposits this in the bank, and directs that 750 RCU be used to reduce the balance on its loan used to purchase the property from P. The bank cannot lend out this money. The bank combines 500 RCU with the 500 LCU paid back by P, and this money is destroyed. The remaining 250 RCU remains credited to Q's loan account. [The bank retains a lien on the left- and right-handed property rights. If either P or Q is in default of its loan obligations, the bank can enforce its rights. If Q is in default, the bank can repossess the right-handed property right, which gives it physical possession of the property, and sell on the right. If P is in default, the bank can freeze the outstanding RCU in P's account until P has repaid the necessary amount of the loan in LCU.] The RCU and LCU created with the creation and sale of the left- and right-handed property rights continue to circulate in the economy. [Their value is based upon a real asset: the property purchased from P by Q, the value of which has been agreed by P, Q and the bank]. They can be exchanged with goods or services [or leant out], just like single currency money, but money cannot be created without the creation of new left- and right-handed property rights and is consumed when these rights are transformed into single property rights. Eventually both P and Q repay their loans from the bank, at which point their original contract, the performance of which the money was based upon, is completed. All 100,000 RCU and LCU are recombined and destroyed. The left- and right-handed property rights are also combined and transformed, so that Q now becomes the sole owner of the property. The bank then applies to the registry to have the changes recorded by the registry, such that [the record of the bank's lien on the left- and right-handed property rights has been removed and] Q is the sole registered owner of the property. This single property right continues until it is extinguished, for example abandoned.

1. A chiralkine system for enabling equitable trade between users, which comprises an information transmission network having a register maintained by a recorder, said register being open to inspection by said users and containing records of chiralkine money and chiralkine property rights created under chiralkine contracts.

2. A chiralkine system as claimed in claim 1, in which the register is an electronic register.

3. A chiralkine system as claimed in claim 1 or claim 2, which is a closed system.

4. A chiralkine system as claimed in claim 1 or claim 2, which is an open system.

5. A web-based system for a bartering organisation and users thereof, which comprises:
(a) means for creating user agreements between said bartering organisation and said users; and
(b) means for implementing user agreements between said bartering organisation and said users, comprising:
(iii) means for representing chiralkine money;
(iv) means for representing and operating user accounts in chiralkine money;
(iii) means for representing monopole property rights;
(iv) means for representing chiralkine property rights;
(v) a web-based bartering market for creating barter transaction agreements between users for monopole property rights or chiralkine property rights in chiralkine money;
(vi) means for creating credit agreements between said bartering organisation and users subject to a barter transaction agreement, for creating chiralkine money and chiralkine property rights;
(vii) means for implementing said barter transaction agreements; and
(viii) means for implementing said credit agreements, including means for creating chiralkine money, means for creating chiralkine property rights when said chiralkine money is created; means for destroying chiralkine money, and means for collapsing chiralkine property rights into monopole property rights when said chiralkine money is destroyed.

6. A system as claimed in claim 5, which is a closed system.

7. A system as claimed in claim 5, which is an open system in which said means for implementing user agreements further comprises:
(ix) means for representing monopole money;
(x) means for creating currency exchange agreements for exchanging monopole money for chiralkine money; and
(xi) means for implementing currency exchange agreements.

8. A system as claimed in any one of claims 5 to 7, in which said means for implementing user agreements further comprises:
(xii) means for representing a register of user property rights.

9. A system as claimed in any one of claims 5 to 8, in which said means for representing chiralkine money is electronic.

10. A system as claimed in any one of claims 5 to 9, which is adapted such that users can communicate with the bartering organisation using a special card that evidences the identity of the user and/or a secret password.

11. A system as claimed in any one of claims 5 to 10, which is adapted such that users can communicate with the bartering organisation using an apparatus having GPS (global satellite positioning) technology.

12. An apparatus selected from a complementary pair of apparatuses capable of communicating each with the other and that together constitute a web-based bartering system as claimed in any one of claims 5 to 11, one being for a bartering organisation and the other for a user.

13. An apparatus adapted for use with left and right handed money, selected from:
a bank card, comprising a machine readable identification code, said card being adapted to handle transactions in left- and right-handed money;
a cash machine adapted to dispense left- and right-handed money;
a cash register adapted to handle and record transactions in left- and right-handed money;
a vending machine adapted to receive money in one of right- and left-handed forms and dispense it in the other; and
an apparatus for use by a bank, comprising left- and right handed money and a computer programmed to maintain records of transactions in left and right-handed money.

14. An apparatus as claimed in claim 13, selected from:
a bank card, comprising a machine readable identification code, said card being adapted to handle transactions in left- and right-handed money; and
an apparatus for use by a bank, comprising left- and right handed money and a computer programmed to maintain records of transactions in left and right-handed money.

15. An apparatus as claimed in claim 14 which is a bank card, comprising a machine readable identification code, said card being a SIM card in a mobile device, said device adapting said card to handle transactions in left- and right-handed money;

16. An apparatus for use by a lawyer, comprising documents representing left- and right-handed property rights and a computer programmed to maintain records of transactions in left and right-handed property rights.
